(19) United States
(12) Patent Application Publication
(10) Pub. No.: US 2023/0050825 A1
(43) Pub. Date: Feb. 16, 2023

(54) Hands-Free Crowd Sourced Indoor Navigation System and Method for Guiding Blind and Visually Impaired Persons

(71) Applicant: Vilnius Gediminas Technical University, Vilnius (LT)

(72) Inventors: Darius Plikynas, Vilnius (LT); Povilas Daniusis, Vilnius (LT); Marius Gudauskis, Kaunas (LT); Arunas Zvironas, Kaunas (LT); Audrius Indriulionis, Vilnius (LT)

(21) Appl. No.: 17/401,348

(22) Filed: Aug. 13, 2021

(51) Int. Cl. G01C 21/20; G09B 21/00; G06F 3/01; G06F 1/16; H04R 1/10; G06N 20/00

(52) U.S. Cl. CPC G01C 21/206; G09B 21/005; G06F 3/015; G06F 3/016; G06F 1/163; H04R 1/1075; G06N 20/00; H04R 2460/13

(57) ABSTRACT

The present invention discloses an indoor Electronic Traveling Aid (ETA) system for blind and visually impaired (BVI) people. The system comprises a headband, intuitive tactile display with myographic (EMG) feedback, controller, and server-based methods corresponding to three operation modalities. In 1^{st} modality, sighted users mark routes, map navigational directions, and create semantic comments for BVIs. This information of routes is continuously collected and estimated in ETA servers. In the 2^{nd} modality, BVIs choose the routes from servers, thereby, are supplied with real-time navigational guidance. Also, an EMG interface is used, where the user's facial muscles are enabled is to send commands to the ETA system. In the 3^{rd} modality, BVIs receive real-time audio guidance in complex or unforeseen situations: ETA provides a crowd-assisted interface and real-time sensory (e.g., video) data, where crowd-assistants analyze the situation and help the BVI to navigate.

### TECHNICAL FIELD

This invention relates to a hands-free wearable electronic traveling aid (ETA) system for blind and visually impaired (BVI) people's real-time indoor, guided navigation. Specifically, the invention discloses a system comprising multi-sensory inputs and machine learning processes together with crowd-assisted interfaces for navigation routing and for solving problematic situations during navigation of a BVI user.

### BACKGROUND OF THE INVENTION

A survey of blind experts has shown that after outdoor navigation, the second most important ETA feature for BVI persons is indoor navigation and orientation, for example, in public institutions, supermarkets, office buildings, homes, etc [1]. BVI persons need ETA for orientation and navigation in unfamiliar indoor environments with embedded features for the detection and recognition of obstacles (not only on the ground but also at eye-level) and desired destinations such as rooms, staircases, elevators, doors, and exits. To-date, BVI indoor navigation in unknown environments is still the most critical task for developers in this area due to a weak Global Positioning System (GPS) signal indoors [2] and costly pre-arranged indoor infrastructural installations (such as WI-Fl routers, beamers, RFID tags, 5G signals, etc.). Thus, some other special techniques or technologies are needed [3].

Solutions tailored to function in very restrictive settings, tests lacking robustness, and the limited involvement of end-users were emphasized as major limitations of the existing ETA research initiatives [4,5]. A tradeoff between the accuracy and costs of developing and deploying an indoor navigation solution was highlighted as a limiting factor after a thorough review of various technologies. Wi-Fi was pointed out as the most economically feasible alternative as long as such infrastructure is properly installed, and the users can tolerate lower accuracy [6]. In a semi-structured survey of BVI experts [1, , a basic understanding of users” expectations and requirements for indoor ETA solutions was presented and enabled the identification of some new developments in the field.

A wide range of general-purpose social networks, web 2.0 media apps, and other smart ICT (information and communication technology) tools have been developed to improve people's daily tasks, including navigation and orientation. Although they are not designed to meet the specialized requirements of BVI people, some features make them useful. For instance, text (and image) to voice, tactile feedback, and other additional enabling software and hardware solutions are helpful for this matter. However, the complexity and abundance of features pose a significant challenge for BVI persons. According to Raufi et al. [8], the volumes of information together with data from social networks confuse BVI users. In this way, Web 2.0 social networks do not guarantee specialized digital content accessibility for BVI users [9]. Some more focused approaches are in demand.

BVI people frequently use apps specifically designed for them to accomplish daily activities. However, N. Griffin-Shirley et al. emphasizes that persons with visual impairments would like to see both improvements in existing apps and new apps [10].

Several, currently available navigation apps are primarily based on pre-developed navigational information but do not provide real-life support, experience-centric user approaches, and participatory Web 2.0 social networking [1, 11, 12]. Other real-life social apps enable access to a network of sighted users and company representatives who are ready to provide real-time visual assistance for the BVI tasks at hand [13]. However, these apps are not adapted to the specific BVI needs in the indoor routes while navigating, orientating, getting lost, etc.

To date, there are no publications or patents, which describe a hands-free BVI indoor navigation approach with crowd-sourced navigational routes, which provides tactile and audio information to the BVI user and which uses facial EMG signals as a source for a user-controlled instructive interface. In the present invention, these issues are addressed.

### SUMMARY OF INVENTION

The present invention integrally and innovatively deals with the following main technical problems that are known in the field of BVI ETA navigation and orientation applications indoors:
1. Real-time step-by-step ETA navigation using intelligent odometry-based guiding maps that are supported by visual, sensory, and semantic information.
2. Employment of a wearable, inconspicuous, and user-friendly headband with integrated, indiscernible sensors and other devices.
3. Hands-free ETA system control interface.
4. A stand-alone computing device or smartphone works as a means for the ETA system's configuration setup, intermediate data processing, and GSM communication.
5. Real-time intuitive tactile display interface and myographic (EMG) user feedback.
6. Employment of machine learning (deep neural networks or other artificial intelligence-based methods) and robot navigation approaches for object recognition and estimation of the best navigational routes, custom routing, semantic analysis, location-aware search, and discovery.
7. BVI real-time access to a Web cloud server and continuously updated indoor navigational routes' database.
8. Web crowd assisted continuous mapping of guiding navigational routes, using sighted users' help.
9. Real-time coordinated audio and tactile BVI guidance in complex, out of ordinary indoor situations, using sighted users' online help.

Above listed technical problems are addressed using an integrated ETA system approach, where proposed innovative hardware components and software applications work in a coordinated manner.

### BRIEF DESCRIPTION OF DRAWINGS

FIG. 1 shows the principal scheme, where rectangular boxes indicate devices. The dotted line delineates the first modality (sighted users mark indoor landscapes); the dashed line delineates the second modality (BVI user receives navigational instructions in real-time based on current position); and the third modality includes the functionality of the second modality supplemented with the real-time web-crowd-assistance.

FIG. 2 shows the ETA system used by a BVI user in the indoor navigation mode.

FIG. 3 shows Modality #1, the web-crowd-based mapping process of intelligent indoor navigational routes for the BVI persons using the ETA system's functionality.

FIG. 4 shows Modality #2, the ETA system's step-by-step BVI guiding process using indoor navigational routes generated in Modality #1.

FIG. 5 shows the Invocation of ETA system's modalities and modes.

FIG. 6 shows a block diagram of the ETA system hardware.

FIG. 7 shows the tactile display: A) front view and B) side view.

FIG. 8 shows the principal scheme of the ETA system hardware operation.

FIG. 9 shows a BVI user's headband (front view with devices uncovered).

FIG. 10 shows the ETA system's software structure.

FIG. 11 shows how the imitation learning-based deep neural network trajectory controller accepts input, combining three components (i) camera image, (ii) one-hot encoded trajectory ID, and (iii) previous navigation command (such as forward, left, right). From the accepted input, the imitation learning-based deep neural network trajectory controller predicts the next navigation command so that by executing it, the BVI user can follow a previously trained trajectory (specified by trajectory ID). By C, we denote convolutional backbone, followed by two fully connected layers FC1 and FC2.

FIG. 12 shows an example of CNN object detector data augmentation.

FIG. 13 shows examples of tactile display operation: A) running wave of vibrators' activations; B) periodic activations of tactile display vibrators; C) projection of camera objects' view to the tactile display view.

FIG. 14 shows the web-crowd-assisted method for indoor routing enhancement and optimization in the first modality using ETA system functionality.

FIG. 15 shows a schematic of the logic connecting the BVI user interface with the ETA system's web cloud database while choosing a route and navigating indoors.

FIG. 16 shows the functionality of the second and third modality of the ETA system.

### DETAILED DESCRIPTION

### Definitions of Abbreviations

BVI—Blind and Visually Impared
ETA—Electronic Traveling Aid
DB—Database
3D-ToF-IR-3D Time-of-Flight Infrared
IMU—Inertial Measurement Unit
GSM—Global System for Mobile
GPS—Global Positioning System
EMG—Electromyograph
EOG—Electrooculograph
CNN—Convolution Neural Network
IMU—Inertial Measurement Unit
OCR API—Optical Character Recognition Application Programming me ace
LSTM RNN—Long Short-Term Memory Recurrent Neural Networks
RCNN—Region Based Convolutional Neural Networks
RFID—Radio-Frequency Identification
RGB—red, green, and blue light additive color model
IR—Infrared Red light
ID—Identification
RNN—Recurrent Neural Network

### OVERVIEW OF INDOOR ETA SYSTEM

The present system is a complex technology of innovatively adapted hardware devices such as a 3D-ToF-IR camera, RGB camera, specially designed tactile display with EMG sensors, bone-conducting earphones, controller, IMU, GPS, light detector, and compass sensors. GSM communication can be implemented in a stand-alone device or smartphone that can work as an intermediate processing device. Passive sensors passively collect environmental data, whereas an active sensor like a 3D-ToF-IR camera emits IR light to estimate distances to the objects, see principal scheme in Mg. 1. Multi-sensory data is used to (i) find needed objects, (ii) locate obstacles, and (iii) infer BVI users' location in an indoor environment to enable navigation. The devices and sensors observe the environment in real-time and send data via the controller to the web cloud server wherein a machine learning processor is configured for feature extraction and object recognition, and a web cloud database stores all data.

From the point of view of a BVI end-user, this invention is distinguished among other related wearable indoor navigational ETA novelties because of a) intelligent user interface based on unique tactile display and audio instructions, b) hands-free programmable control interface using EMG, c) comfortable user-orientated headband design, d) machine learning-based real-time guidance, e) web-crowd assistance while mapping indoor navigational routes and solving problematic situations in real time.

For efficient indoor navigational performance, the presented ETA system is used in three consequently interconnected modalities:
1) In a first modality, web crowd assistance when sighted users go through buildings and gather step-by-step indoor route information that is processed in the web cloud server and stored in the online DB;
2) In a second modality, BVI usage of web cloud DB indoor routes for guidance and navigational assistance;
3) In a third modality, during complex indoor situations (such as getting lost, encountering unexpected obstacles and situations), the BVI ETA system's multisensory data stream can be shared in real-time to get voice-guided help from sighted users familiar with that particular route or building.

Hence, in the ETA system's first modality, buildings' indoor objects and routes are practically explored and recorded by sighted users using the present ETA (electronic traveling aid) system. The sighted users go through the indoor routes, comment on objects, and mark key guidance points while wearing a hand-free device. In this way, sighted users mark indoor landscapes, map navigational directions, and make comments using the system's web crowd-assisted interface. Input data from indoor routes is processed in the web cloud server using a machine learning algorithm and collected in the web cloud database. The best statistical options for successful navigation are estimated periodically in the web cloud DB using deep neural networks or other artificial intelligence-based methods. In this way, BVI users can choose the fastest, shortest, stair-free, most used, best rated, most recent, or other route options. Route updates are continually sent from the sighted users and BVIs to the web cloud server. Such assistance works through social networking when relatives, neighbors, friends, and other people voluntarily and periodically use the ETA system to record indoor routes most important for BVI. Therefore, even various ever-changing indoor situations like renovations, furniture movements, closed doors, and the like can be recorded and updated continually through social networking. We consider such a social networking approach as an essential innovation method in the field of ETA applications for the BVI.

In the ETA system's second modality. BVI persons can choose a building and the desired indoor destination from the web cloud DB. Based on the user's preferences, the best route is suggested (fastest, shortest, stair-free, most used, best rated, most recent, or other options) based on the analyzed, semantically enriched, interpreted, and statistically validated indoor routes using information gathered in the ETA system's first modality. In this way, BVI can use navigational instructions to (i) get acquainted with the chosen route and (ii) use the instructions while orientating and navigating indoors. Machine learning and robot navigation approaches are innovatively adapted for this task. Robot navigation means a robot's ability to determine its position in its frame of reference and then plan a path towards some goal location. Following modern computer vision (visual odometry) based on autonomous robot navigation techniques (representations of the environment, sensing models, and localization algorithms), a similar visual odometry-based approach is applied to navigate BVI persons indoors. In the preferred embodiments of the instant invention, the indoor map building approach uses sighted users' DB of collected routes and an audio-tactile guiding interface. After a navigational experience is complete, BVI user's feedback is used to evaluate, improve, and rate navigational route information in the web cloud DB, see FIG. 1. Such feedback is used to improve route estimates and route validity by the end-users.

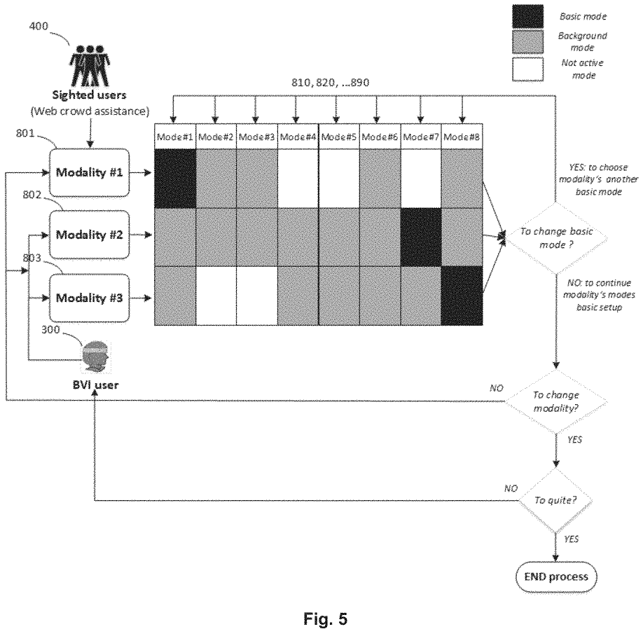

In the third modality, while using the ETA system for navigation, BVI users can get online assistance in complex, unanticipated indoor orientation and navigation situations, lit is designed to help BVI users when they are in unanticipated situations that the pre-computed routes and ETA guidance cannot resolve (i.e. deviating too far from the prescribed route, encounter unrecognized obstacles, etc.) while navigating indoors in the second operational ETA modality. In those situations, BVI users can manually, using voice commands or EMG signals, switch from the second to the third modality to resolve the problem and later return to the second operational ETA modality and continue on the guided navigational route (see FIG. 1. and FIG. 5).

In the third modality, a web crowd assistance interface is activated. That is, BVI users via the ETA system's mobile application can initiate a communication session with a selected sighted user. The ETA system sends the selected sighted user the BVI cameras' views, last successful location ID, sensory information, building evacuation map or other building interior layout schemes. Being provided all this information, the selected sighted user can make real-time suggestions in complex situations and help resolve the problem.

Thus, the ETA system's web crowd assistance interface ensures (i) real-time mobile connection between BVI and sighted users, (ii) delivery of BVI user's sensors information to the sighted user, (iii) delivery of third parties information concerning layout of the buildings to the sighted user The designed mobile application is a technical interface to transfer the information mentioned above and communication between a BVI user and a sighted user.

Thereby, sighted users can help interpret the route, current position, obstacles, or other surrounding complex circumstances by using information sent from web cloud DB and from the BVI ETA system's cameras. While the current camera view is provided to the registered sighted user, it is often not enough for the sighted user to make meaningful supporting decisions because they need to understand the contextual grand view. Therefore, sighted users can get additional information from the ETA system and online DB about BVI's current or last confirmed position on the current route map. The ETA system can also provide time, speed, and movement direction since the last confirmed position, suggesting where the BVI user went astray and where the BVI user is currently located, Additionally, sighted users can retrieve budding floor schemes and other relevant information from the third parties collected in the online DB.

Although the invention has been briefly described by way of preferred modalities, it is to be understood that various other adaptations and modifications may be made within the spirit and scope of the invention.

### PRINCIPAL SCHEME

A wearable system is configured to help navigate blind and visually impaired (BVI) people 300 in an indoor environment. It comprises passive sensors (RGB camera, IMU, GPS, light detector, EMG) and active sensor (3D-ToF-IR camera) 110-150 (Mg. 1), which observe the environment in real-time. Sensors 110-150, tactile display 520, bone-conducting earphones 510, and myographs 110, together with a controller 600, are implemented in a wearable and comfortable headband 300. Processed and interpreted environmental real-time data is sent back to the user in the form of an instructive audio-tactile interface with the help of the bone-conductive headphones 510 and a specially designed vibrotactile display 520. A hands-free control interface is implemented using a myographic input 110, in which facial muscles are used to send operational commands to the system, or speech recognition.

BVI users can also interact with the ETA system using hand gestures 210, which are captured by the BVI user's camera and interpreted by the ETA machine learning algorithms 800, one of which can recognize hand gestures that signify to pinpoint smaller visual regions for an object's closer examination, zooming, or text recognition in the indicated area (see Mg. 1).

A smartphone, configured with this ETA system application 240 and a web cloud server 700 are coupled to the system controller 600. Machine learning and computational vision processes 800 recognize and couple the multi-sensory data into meaningful patterns. Useful objects, specific user-defined objects, and scenic views are depicted and interpreted using deep neural networks or artificial intelligence methods. Multi-sensory data is used to (I) find target objects, (ii) locate obstacles, and (iii) infer users' location in an indoor environment for navigation.

The system can be used in three modalities (FIG. 1), In the first modality, buildings' indoor objects and routes are practically explored by sighted users, and data is collected and stored in a web cloud database 900. Sighted users a priori mark indoor landscapes, map navigational directions, and make comments using the system's web crowd-assisted interface 400. Sighted users and BVI users can constantly update the input information, and the best statistical options for successful navigation are estimated periodically, with the addition of new data, in the web cloud server 800 using deep neural networks or other artificial intelligence-based methods and stored in the web cloud DB 900.

In the second modality, BVI users 300 can choose a building and desired inside destination from the web cloud DB 900. For that reason, the system provides a statistically validated indoor route using information gathered in the first modality. In this way, BVI can use navigational instructions to (i) get acquainted with the chosen route and (ii) use it while orientating and navigating indoors. Machine learning and robot navigation 800 are innovatively adapted for this task. After the trip, BVI users' feedback is used to evaluate, improve, and rate navigational route information in the web cloud DB 900, see FIG. 1.

BVI users 300 can get online audio help in complex, unanticipated indoor situations in the third modality. Using smartphones 240 and the web crowd-assisted interface 400, BVI can call a sighted user 400 who is familiar with that building and indoor route.

Sighted users help interpret route, current position, and visual information sent in real-time from (i) the web cloud DB 900 and (ii) the BVI system's cameras 120, 150, see FIG. 1.

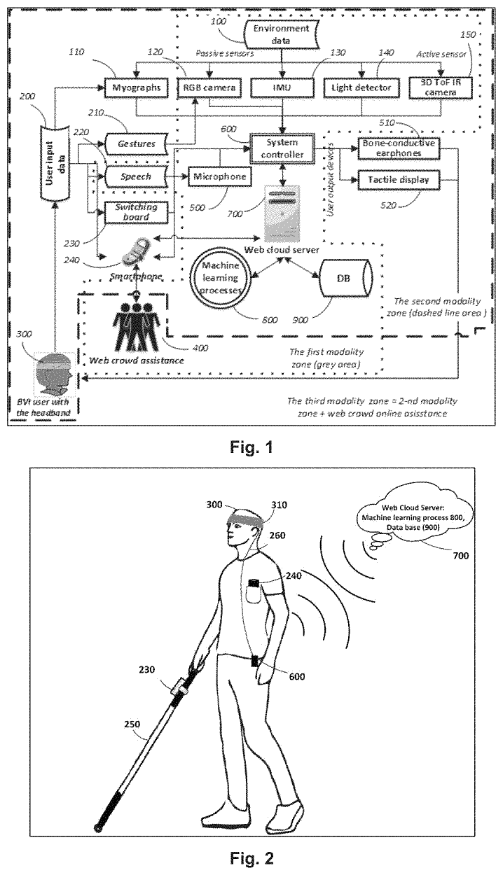

According to FIG. 2, the BVI user 300 wears a headband 310 that is connected to the system controller 600 via the system bus 260. In one embodiment, a switching board 230 placed on white cane 250 is used for selecting of ETA system operation modality or operating mode. However, in the the preferred embodiment, BVI users use a facial EMG (electromyography) 110 interface for hands-free switching.

In the third modality (FIG. 1), the BVI user 300 can employ a smartphone 240 for communication with the sighted users using the web crowd-assistance interface 400. In all modalities, a smartphone 240 (or small single-board computer) can be used for individual ETA system configuration, tagged modalities and mode selection, and video and voice information exchange with Web cloud server 700.

In the absence of WiFi, a mobile Internet connection is used from the BVI user's 300 smartphone 240. Otherwise, the 4G/5G wireless communication installed in the system controller 600 is used for data exchange with the web cloud server 700, as well as for the possibility to contact a sighted user 400.

### MODES AND MODALITIES

To meet BVI user's needs for indoor navigation and orientation, the ETA system's hardware and software can integrally operate in three modalities, see FIG. 1.

Modalities 801-803 can be interpreted as the ETA system's basic working regimes, each characterized by a default set of eight differently activated operational modes 810-890, see FIG. 5. The set of ETA system's modes are:
Mode#1 810: object detection and class identifier
Mode#2 820: identification of specific (user defined) objects
Mode#3 830: audio description of visual scene
Mode#4 840: face recognition
Mode#5 850: optical character recognition
Mode#6 860: obstacle recognition
Mode#7 870: indoor navigation
Mode#8 880: social networking

Modes can work in three different ways—basic, background, or not active (see FIG. 5). A basic mode is fully operational in the sense of employed ETA system's resources and input/output interfaces (for instance, audio 510 is used as a main output channel for the basic mode). Background modes work without disturbing a BVI user 300 until an urgent situation is detected, which has to be immediately addressed. For instance, in Modality #2, the navigational mode 870 is basic, and object detection mode 810 works in the background, making tactile 520 warnings when close obstacles are detected.

Thus, in each modality 801-803, only one basic mode can be activated (see FIG. 5). Each operating modality is operated by a default set of modes 810-890 - one basic and others acting in the background. ETA's system's user 300 can change the basic mode in each modality. For instance, when the ETA system operates in Modality #2, mode#7 is basic, but the BVI user 300 can change it to, e.g., mode#3 if he/she wants to hear more about the scenes.

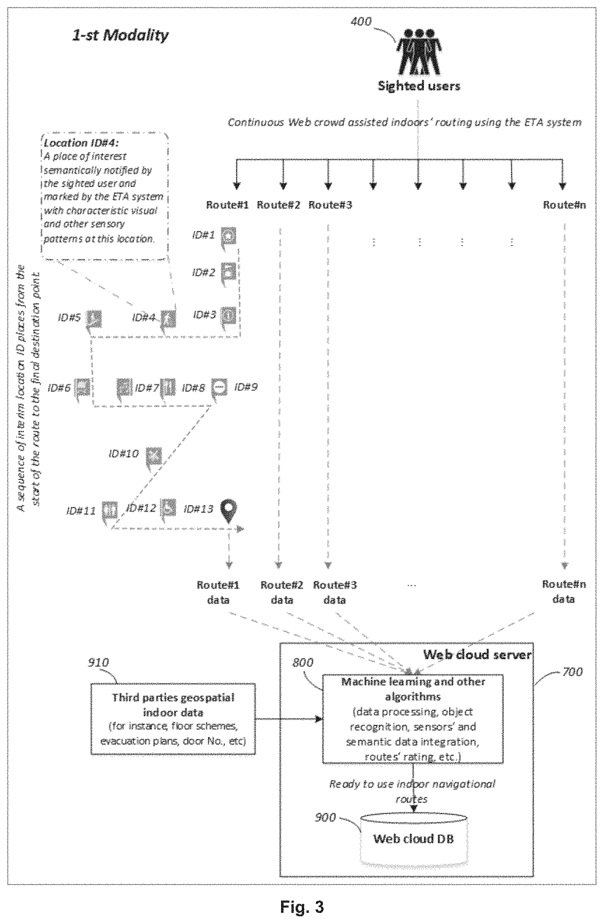

It is important to note that in the ETA system, all three modalities 801,802, and 803 work in coordination with one and another. First of all, it is crucial that Modality #1 801 is used for collecting indoor navigational route data by sighted users 400. Modality #1 utilizes the ETA system's functionality that includes specially designed sighted users' environment in the mobile application, which transmits navigational and semantic data for processing and storing in the web cloud database 900 (see FIG. 3). In this way, the sighted users' environment of the mobile application programmatically empowers the web crowd assistance interface with the ETA system. Continuous participation in the first modality by sighted users 400 provides updated indoor route information. The ETA system works as an open, collaborative (online/offline) DB of guided indoor routes maintained by a community of sighted users (relatives, friends, neighbors, volunteers, etc.). The ETA system's web cloud server 700 processes the indoor route data and makes it available for the BVI users in the second and third ETA system's operational modality.

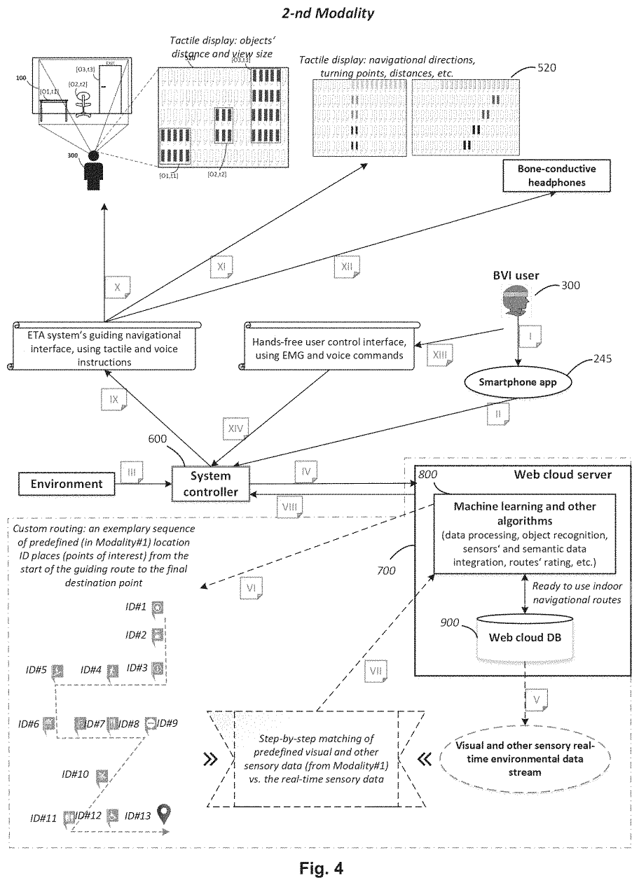

In the preferred embodiment, sighted users gather route information by walking indoors and step-by-step semantically commenting on points of interest (like stairs, entries, exits, doors, WC, etc.) using the ETA system in Modality #1 (see FIG. 3). It is important to note that during such routing, the ETA system step-by-step gathers visual and other sensory and semantic information, producing an intelligent odometry-based guide map with points of interest (location ID places) for the BVI user to use in Modality #2, see FIG. 3 and FIG. 4,

### MODALITY #1

In the first modality 801, sighted users 400 go through buildings and gather indoor route information to be stored in an online DB 900 where the machine learning processes 800 take place in a web cloud server 700 (see FIG. 3 and FIG. 5). In modality #1, the ETA system's software 600, 700, and 800 functionality is based on integrating data streams from the active modes 810-880, where mode#1 810 is the default mode and other modes work in the background or are not active. Using data from sighted users 400, the ETA system generates navigational routes for BVI users, Machine learning algorithms (e.g., deep neural networks) 800 are used to integrate data stemming from sensors (110, 130, and 140), cameras (120 and 150), semantics (e.g., sighted users' comments), and third parties' geospatial floor plans, etc. The integrated data is used to generate routes as sequences of interconnected location ID places with associated image and audio information that can be tracked on an interactive map (see FIG. 3). Routes with navigational information can be accessed either offline or online.

### MODALITY #2

In the second modality 802. the web cloud servers 700 navigational route information (stored in online DB 900) is used by BVI users 300 for indoor navigational purposes in a chosen building. FIG. 4, depicts step-by-step BVI guiding process using indoor navigational routes generated in Modality #1:
Step I: ETA system setup.
Step II: Selection of guiding indoor route and destination according to the BVI user preferences, using mobile app.
Step III: Getting into appropriate indoor environment.
Step IV: Initializing data stream from the indoor environment.
Step V: Visual and other sensory real-time environmental data stream.
Step VI: Custom routing of predefined (in Modality #1) location ID places (points of interest) from the start of the guiding route to the final destination point.
Step VII: Step-by-step matching of predefined visual and other guiding route sensory data (obtained in Modality#1 and storred in web DB) vs. the real-time sensory data.
Step VIII: ETA system's guiding instructions.
Step IX: ETA system's guiding interface, using the guiding ETA system's tactile and voice instructions.
Step X: Objects (targets, obstacles) depiction using forehead mounted tactile display (indication of object class, direction, distance, etc.).
Step XI: Step-by-step navigation instructions, using forehead mounted tactile display, location aware search and discovery, detailed point of interest, etc.
Step XII: Semantic voice comments (scenery descriptions, mode change confirmations, etc.).
Step XIII: BVI user hands-free control interface with the guiding ETA system, using and/or voice commands.
Step XIV: Modality or basic mode change, addition of semantic comments, new location IDs, etc.

Based on the user's preferences (fastest, shortest, stair-free, most used, best rated, most recent, or other options) the machine learning software 800 suggests the best route. The ETA system provides analyzed, semantically enriched, interpreted, and statistically validated indoor routes using information gathered in the first modality. In this way, BVI users can use navigational instructions to (i) get acquainted with the chosen route and (ii) orient themselves and navigate indoors. Machine learning 800 and robot navigation approaches are innovatively adapted for this task.

After the trip, BVI users' 300 feedback is used to evaluate, improve, and rate navigational route information in the web cloud DB 900. BVI users 300 can make additional comments and mark location IDs. Such feedback helps to estimate the route and improve its validity by the end-users, BVI 300. For that reason, ant colony optimization algorithms (SWARM intelligence) can be adapted. This probabilistic technique solves computational problems, which can be reduced to finding the right paths through graphs. That is, sighted users and BVI serve as SWARM agents who help the ETA system find the best routes.

### MODALITY #3

In the third modality 803, while using the ETA system for navigation, BVI users 300 can get online web crowd assistance in complex, unanticipated indoor orientation situations such as getting lost or encountering unexpected obstacles. The ETA system can be used in real-time to get voice-guided help (through bone-conductive headphones) 510 from a sighted user 400 who is familiar with the particular route or building. It is important to note that modes#1-7 810-870 (see FIG. 5) can work in the background, optionally informing the BVI user 300 about the environment 100. Using a smartphone app 245 and a web crowd assisted interface, the BVI users 300 can initiate a communication session with a selected sighted user who is familiar with that building and indoors route.

Sighted users' contact information is contained in the online DB if they volunteer to consult BVI in complex situations while traveling through routes known to the sighted user. A preferred sighted user is familiar with the indoor ETA guiding system and with some indoor routes they have traveled. Therefore, such sighted users are selected by the ETA guiding system. Their contacts are sent via the mobile application 245 to the BVI user to provide verbal assistance interpreting routes, current position (if they are lost), obstacles, or other surrounding complex circumstances on the route. Suppose a sighted user, who is well familiar with the particular route, is not available for immediate online communication. In that case, using the mobile application, the ETA system provides to the BVI user a list of other sighted users who can be contacted based on the rankings obtained from the BVI users' rating feedback.

A selected sighted user is provided with relevant information from web cloud DB 900 and the BVI ETA system's cameras 120, 150, which provides the current camera view to the sighted user 400. The information provided to the selected sighted users 400 may include the BVI user's current or last confirmed position on the current route map. The ETA system can also provide time, speed, and movement direction since the last confirmed position, suggesting where a BVI user went astray and is currently located. Besides, sighted users can retrieve building floor schemes and other relevant information from the third parties collected in the web cloud DB 900. Equipped with all this information at hand, sighted users can provide useful navigational support for the BVI users 300 in complex indoor situations, especially if the system can select those sighted users 400 who are familiar with that building or route.

### HARDWARE

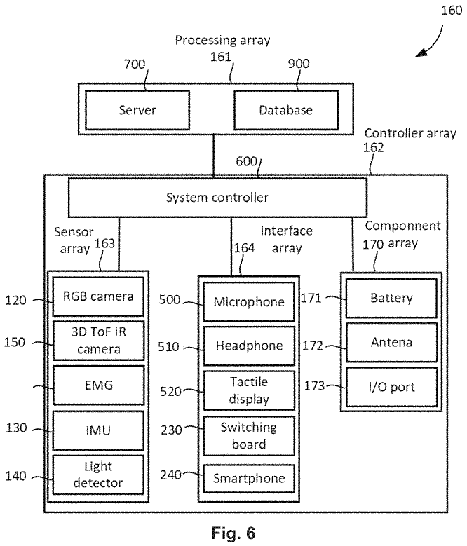

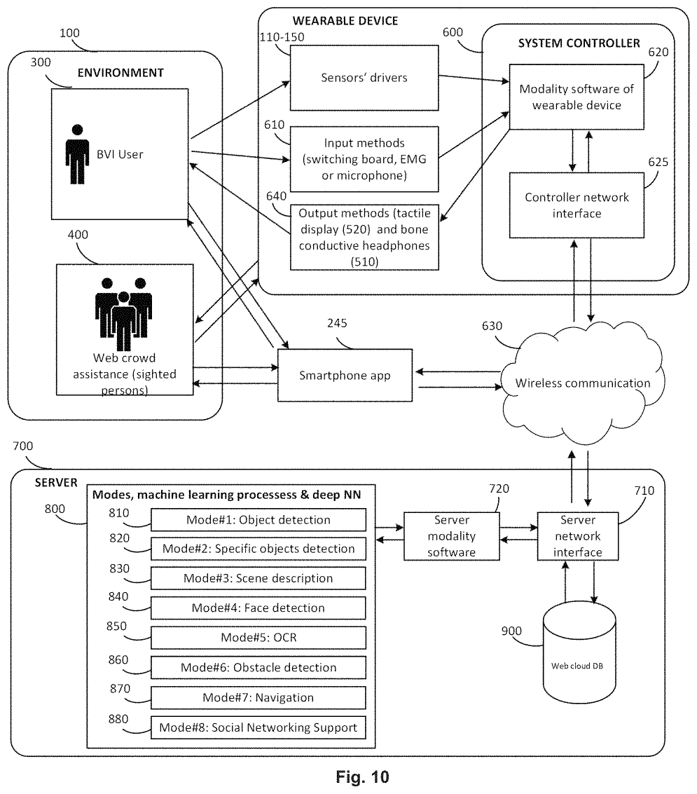

The composition of hardware elements provides hands-free commands input via EMG 110 or microphone 500 and environment information feedback transfer to forehead via vibrotactile display 520. Control of these hardware elements is closely related to software, see FIG. 6 and FIG. 10. FIG. 6 shows a block diagram of an ETA system 160 according to the preferred hardware embodiment. The ETA system 160 includes a processing array 161, which communicates with a controller array 162 consisting of the sensor array 163, an interface array 164, and a component array 170. The processing array 161 includes the web cloud server 700 and the web cloud database 900. The server 700 may be a powerful web cloud video processing-based computer. The database 900 may be a part of the server 700 or a separate web-based data storage.

In the first modality (see FIG. 1 and FIG. 3), a building's indoor objects and routes are practically explored and recorded by sighted users using the ETA system. The best statistical options for successful navigation are estimated using deep neural networks or other artificial intelligence-based methods 800 on the web cloud server 700 and updated periodically, when new information is received, in the web cloud DB 900.

In the first modality, route updates are continually sent from the sighted users and BVI users, which works through social networking via the mobile application 245.

Therefore, various changing indoor situations like renovations, furniture movements, closed doors, and the like can be recorded and updated continually in the web cloud DB 900.

In the controller array 162, a system controller 600 may be application-oriented integrated circuits (ASIC), low-cost ARM-based microcontroller, small single-board computer, or other embedded computers. An antenna 172 is used for communication with the input device 270 (switching board 230 or smartphone 240),

The sensor array 163 includes an RGB camera 120. a 3D-ToF-IR camera 150, electromyograph (EMG) 110, an inertial measurement unit (IMU) 130, and a light detector 140.

Passive sensors passively collect environmental data, whereas active sensors like 3D-ToF-IR camera 150 emits IR light to estimate distances to the objects. The sensors 163 observe the environment in real-time and send data via the controller 600 to the machine learning processing 800 on the web cloud server 700, where feature extraction, recognition, and storage occur in the web cloud database 900.

The RGB camera 120 is used for color image input, which is in turn, used to detect a set of trained object classes that are essential to BVI users (such as corridor, door, elevator, stairs). The color images are also used to detect and recognize faces wherein a list of recognized faces can be managed by a user. The RGB camera 120 is also used to accept color images and provide a textual description of the depicted scene, This textual information is provided to the BVI user through the audio channel 510 (headphone).

The IMU 130 may comprise an accelerometer, a gyroscope, a magnetometer, and/or an acceleration or positioning sensor. The lMU 130 may be utilized to determine the positioning of the user and/or the cameras 120, 150. The system continually tracks IMU 130 information, which allows tracing the BVI user 300 route back to the last known location ID. While navigating indoors with ETA guiding system when BVI person 300 gets lost or disoriented, the system can make a dead reckoning, i.e., guide the user to the last known location ID place.

The light detection 140 in the sensor array 163 can provide additional information about the BVI user's environment. For example, a light detector may be used to assess the level of illumination in the environment during graphical information processing.

The interface array 164 includes a microphone 500, a headphone 510, a tactile display 520, a smartphone 240, and optionally, a switching board 230.

In the third modality, when a BVI user 300 encounters complicated indoor navigation situations like (i) deviation from the chosen route, (ii) unpredicted obstacles that cannot be avoided, (iii) missing next location ID, and so on, then the BVI user 300 can initiate a communication session (using smartphone 240 or other devices) with a selected sighted user 400 for online assistance to resolve the problem. During the communication session, the sighted user 400 can obtain almost real-time access to the BVI user's 300 camera 120,150 views. In a preferred embodiment, a BVI user 300 initiates the mobile application's web-assisted interface, which can transfer the ETA system's camera video streams to the BVI user's mobile phone 240 and then through the GSM connection to the selected sighted user's mobile phone. In other embodiments, it is possible to make transmission directly from the BVI user's wearable system's integrated GSM wireless communication module to the remote sighted user's mobile phone. The BVI user can select a sighted user to contact from a ranked list provided in the mobile application, A sighted user familiar with that indoor location (for instance, he/she participated in mapping that indoor terrain in Modality #1) is on the top of the list.

The microphone 500 is a device capable of receiving voice commands and letting the ETA system work in the hands-free mode in the second and third modalities.

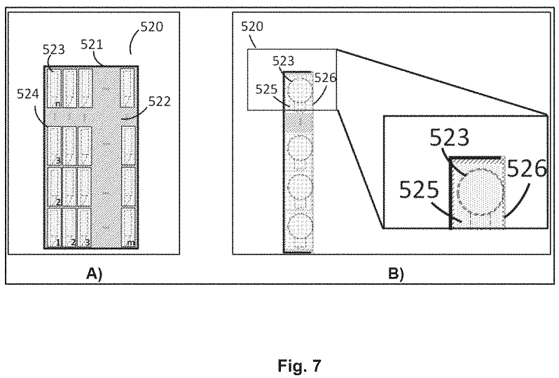

Referring to FIG. 7A, the tactile display 520 consists of at least n-row and rn-column vibrating motors. The base 521 of the tactile display is preferrably made of elastomer 525. Each vibrating motor 523 in the cell 524 is immersed in an elastomer 525 of different stiffness than the base 522 so that the amplitude of the movement is maximized and so that the movement is not transmitted to adjacent cells.

The system controller 600 can output a pulse-width modulated signal FIG. 7B to drive the vibrational motors 523. The vibrating motor 523 in the cell 524 must move perpendicular to the forehead. The matrix is covered with a human-friendly biocompatible elastic material 526.

Referring to FIG. 6, the switching board 230 may be a device having four or more buttons that can be used to select one of eight modes (see FIG. 5). The switching board 230 may be separate from the system controller 600; for example, it may be placed on the BVI user's 300 white cane (see FIG. 2) and would communicate with the system controller 600 through an antenna 172 configured with Bluetooth or \Aii-Fi capabilites, The component array 170 includes a battery 171, an antenna 172, and an input/output (I/O) port 173. The battery 171 may be a battery or other power supply capable of powering the system controller 600. For example, the I/O port 173 may be a headphone jack or a USB data port. The battery 171 can be connected to an external power source or outlet via a power cord. There may be an option to charge the battery 171 via wireless charging,

The antenna 172 may be one, or more antennas, capable of transmitting and receiving wireless communications. For example, the antenna 172 may be a Bluetooth, Wi-Fi antenna, and/or mobile telecommunication antenna (e.g., fourth or fifth generation (4G, 5G)).

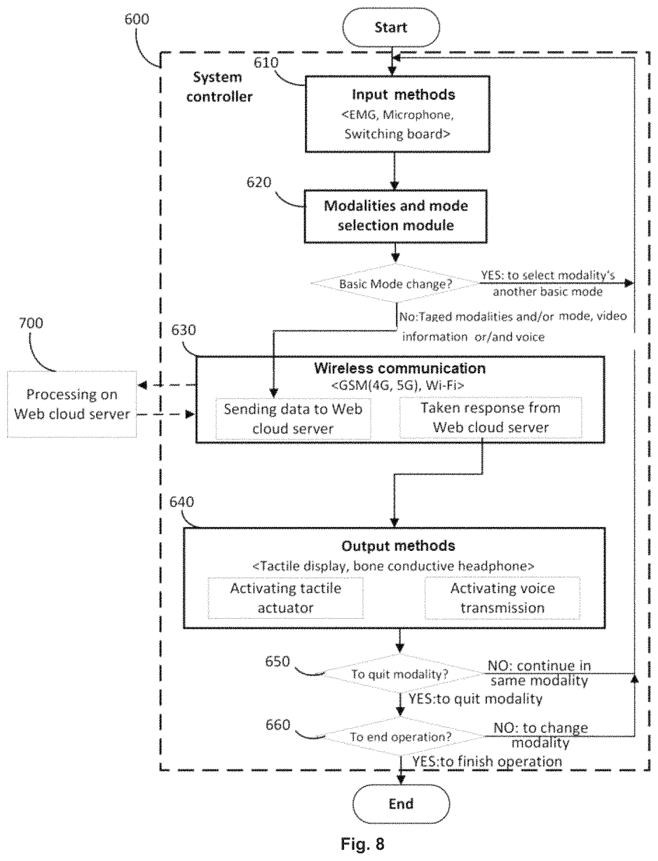

FIG. 8 presents a schematic of ETA's system hardware operation, wherein the system controller 600 consists of an input module 610, which is configured to execute several input methods, a modalities and mode selection module 620. a communication module 630, and an output 640 module. The system controller is a central part of ETA system's information exchange protocols with the web cloud server 700.

Referring to Mg. 5, ETA's system user sets one of three modalities (801, 802, or 803) with basic and background operating modes (810-890). The choice of system operation depends on the user. In the indoor guiding ETA system, there are two types of users:
1) Sighted users who operate in modality #1 whereby the sighted user a priori performs the recording of indoor routes with semantic markings of points of interest and can remotely, via web crowd interface mobile application, assist BVI users when they are in modality #3 (encounter complex situations and need sighted users' real-time assistance).
2) BVI users who employ modality #2, indoor guided navigation and orientation using route maps generated by sighted users in modality #1 and modality #3 when they encounter complex situations.

During operation, the BVI user 300, using the input module 610, selects one of the systems operating modalities 620. An ETA's system user can select one of three operation modalities (FIG. 5). The input module 610 consists of an input myograph (EMG) 110, a microphone 500, or a switching board 230 on a white cane 250. In the case of EMG 110, operational modalities can be selected with eye blinks; in the case of using microphone 500, the voice command of the BVI user 300 will is used for selections; or in the case of a switching board 230, pushing the selected button by the BVI user 300 will be used for selections. The input modules 610 of the ETA system are configured individually by BVI users 300. When the operation modality and operating modes are selected, a flag is generated indicating which subsystem is switched on. This information, along with video and/or audio information, can be sent to server 700. All options will require cameras: RGB 120 and depth 150 camera.

The wireless communication module 630 transmits the video and/or audio information together with the operation flag of the system variant 631 to server 700 for further processing. The wireless communication module 630 uses an active mobile phone 240 or a selected GSM hardware wireless communication module with 4G-connection to exchange information between the server 700 and other system modules, The information received 632 from the server 700 is processed to isolate the operating variant and activate the corresponding output module 640: tactile display 520 or bone-conducting headphones 510; in some of the cases, it may be both modules. It is then determined whether the BVI user 300 tries to change the basic mode or quit the modality. If nothing is selected, the ETA system continues the operation in the same modality. If the user makes a selection, the server determines whether the BVI user 300 wants to end the operation or to select another operation modality.

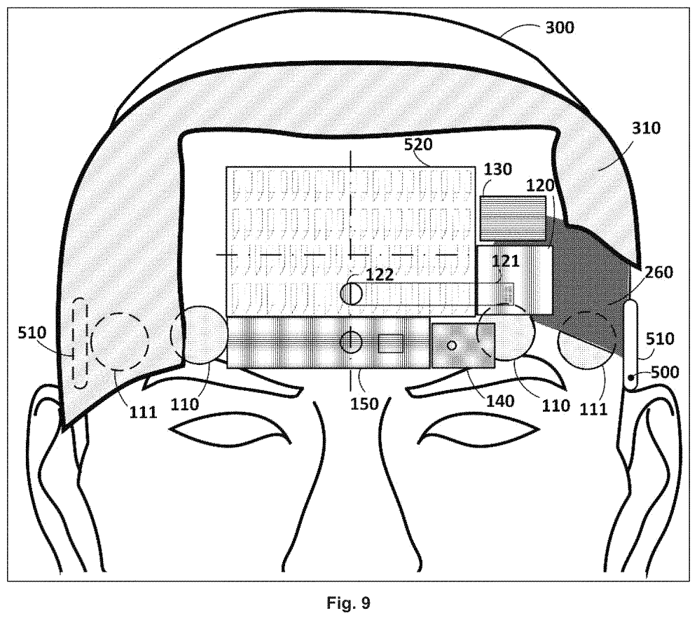

FIG. 9 illustrates headband 310 used by BVI users 300 in the second and third modalities, In the first modality, sighted users 400 traverse building interiors wearing the headband 310 and gather indoor route information, The electromyographs 110, 111 and output devices (bone-conductive earphones 510 and tactile display 520) are not used. The headband includes the tactile display 520 with nxrn vibro-motors 523 for tactile feedback (see FIG. 7), ROB camera 120 (lens 122, lens cable 121) and 3D ToFIR camera 150 for graphical information input, light detector 140, an inertial measurement unit (IMU) 130, EMG sensors 110, 111 for hands-free system control, bone-conducting earphones 510 for audial feedback, and the system bus 260 for exchange of data and control signal with the system controller 600.

The ROB camera 120 and 3D-ToF-IR camera 150 provide information about the wearable device's depth and distance—it is also possible to better identify the elements of the environment around the user in this way. Combining the IMU 130 and the cameras 120,150 is beneficial because the combination can provide more accurate feedback to the user. The light detector 140 will help evaluate the room's lighting and make appropriate adjustments when processing the image.

The ROB camera 120 may consist of the control part which can be connected via cable 121 (for flexibility) to the lens 122, as shown in FIG. 9.

The EMG sensors 110, 111 illustrated in FIG. 9 are arranged to measure the frontalis and temporalis muscle contractions (a contraction of eyebrows). Two electrodes 111 are located on the left and right temporalis muscles. Because the temporalis muscle lies relatively close to the face and temples, its motion is detected by the same pair of electrodes used for hEOG [30].

The input module can receive input data streams such as hand gestures 210, EMG 110 signals, verbal commands using a microphone 500, and a switching board 230 on a BVI white cane 250. Vibrational motors 523 of the tactile display 520 are arranged perpendicular to the forehead of the BVI user 300 (see FIG. 7) to achieve higher resolution and perception quality when receiving output. Such an approach has not been applied elsewhere.

A unique, hands-free command and entry-confirmation interface is offered. The designed ETA system can recognize BVI users' 300 predefined commands by EMG signals through electromyographic sensors 110, 111. The ETA system uses machine learning algorithms 800 to learn each users EMG control signals commands. The system captures signals and reports to the user about detected and recognized commands via bone-conducting headphones 510 or tactile display 520. If the right command is received, the BVI user 300 confirms the control command either using another EMG signal (110, 111), voice command (500), or nodding his head (in the latter case, EMU 130 parameters are captured). Then, the ETA system is ready to accept the next command via the EMG sensors 110, 111. The command sequence and type can be encoded individually by each BVI user 300.

The mobile interface (mobile phone 240) is also used to enter verbal information. In the first modality, sighted users 400 send comments to the web cloud server 700 about obstacles or other information that may be useful to BVI users 300 about the route. In the third modality, the mobile interface is used by the BVI user 300 to contact a selected sighted user to receive support in complex and unanticipated situations.

In the case of entering verbal commands, a microphone 500 operates through which commands are received in the system controller 600 and then the commands are passed to the web cloud server 700 to execute selected commands.

With the switching board 230, commands are transmitted to the system controller 600 via a wireless interface (such as Bluetooth, Wi-Fi, or 4G/5G communication networks), and are further routed to the web cloud server 700 (if necessary) for the execution of selected commands.

The user output module 640 consists of an audio information transmission device, such as a bone-conductive headphone 510 and a vibrotactile display 520 (see FIG. 7),

Depending on the operation modality, the output devices can operate individually or together. For instance, when the ETA system is in the second modality (BVI navigation mode), guiding directional information is transmitted to the user via audio voice (headphone 500) and tactile display 520 in a mutually coordinated manner.

### SOFTWARE

The software system is implemented on a binary platform (wearable device-system controller 600 and server) and encapsulates software elements listed below.

Sensor drivers: sensor interface 110-150 consists of software for reading systems sensor data.

User input 610 and output 640 modules compose a cantral interface, which allows to:
1. Navigate between device operation modalities.
2. Change basic modes within each modality.
3. Setup individually preferred ETA system's operational parameters like basic EMG coding, output refreshing rate, etc.

Such control interface utilizes drivers for (i) a switching board 230, EMG 110, microphone 500, and gestures 210 as control input methods 610 and (ii) audio bone-conductive earphones 510 and tactile display 520 as control feedback output methods 640, see FIG. 1 and FIG. 10.

Network interfaces: wearable controller network interface 625, wireless communication 630, and server network interface 710 make data connections between wearable and remote system components.

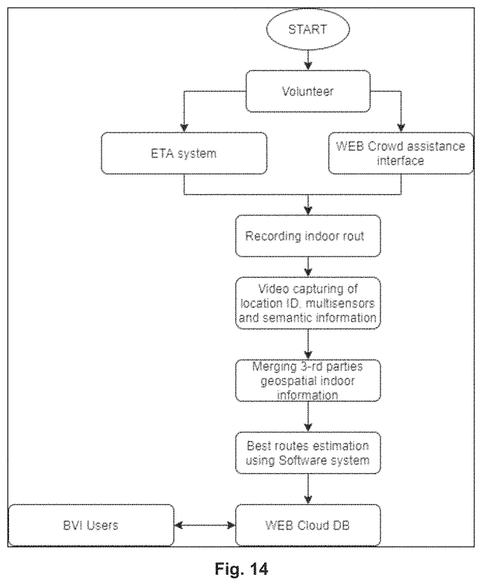

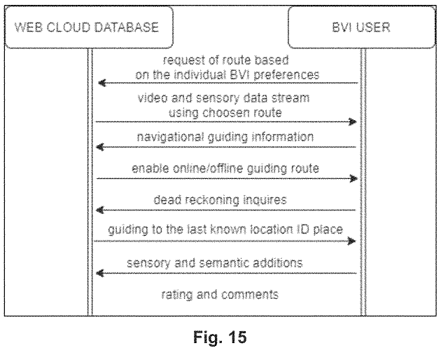

Smartphone app 245 is used by BVI users in the first modality to configure the main parameters of the ETA system. It is also used by the BVI persons and sighted users in the third modality (see FIG. 1, FIG. 14, and FIG. 15) to make a call and get guiding in complex situations. For that matter, different smartphone app 245 functions are engaged.

Modality software: The ETA system's operation modalities are implemented as modality software 630, 720 based on software libraries (modules), describing the system's operation at different scenarios (e.g., see FIG. 5). These modules may use entire systems hardware and software functionality, both from wearable and server platforms.

Modes modules. A set of computer vision, navigation, and social networking support modules correspond to different basic modes 800. The user can activate these modes via a control interface 610.
1. Object detector 810. Although this module is based on Faster RCNN (Faster Region Based Convolutional Neural Network - integrates the reggions of interest generation into the neural network itself) in our implementation, any other object detection architecture can also be used. It accepts color image input from an ROB camera and detects a set of trained object classes, which are essential to BVI users (e.g., corridor, door, elevator, stairs, etc.). Each detection consists of rectangles in the camera image, paired with the corresponding class labels and reliability scores. The CNN (Convolutional Neural Network) object detection is trained by a standard gradient descend method and custom training data augmentation algorithm (see Algorithm 1). Our application object class detector can be useful to detect physical objects and regions in an image having specific properties (e.g., traversable/non-traversable area).
2. Specific object detector 820. This module also accepts color image input from the user camera and detects a set of pre-trained objects. The main difference is that this module relies not on a CNN object detector but template matching, which allows the system to instantaneously learn new objects. Because new object learning is performed just as the inclusion of corresponding images into the object model's database, new objects can be included by the BVI user or by support users, The module can be implemented using third-party software solutions
3. Scene description module 830 accepts color image input from the user's camera and provides a textual description of the depicted scene. This module utilizes CNN to extract features from the input image and LSTM RNN (Long Short-Term Memory Recurrent Neural Network) to map it to a textual representation.
4. Face recognition module 840. This module accepts color images and detects and recognizes faces within them. Users can manage the list of faces which can be recognized. The module can be implemented using third-party software solutions.
5. Optical character recognition (OCR) module 850 relies on the CNN object detector module and commercial OCR API composition. The CNN object detector is used to detect user's hand gestures, which potentially contains useful text. Afterward, this corresponding region is processed via OCR to extract text.
6. Obstacle recognition module 860 relies on the information from the depth camera. It detects obstacles, which would be hard to detect with a white cane (e.g., obstacles in the upper body region). Standard point cloud segmentation methods detect obstacles.
7. Navigation module 870 relies on imitation-learning deep neural networks and object detection components. The imitation-learning component allows to record and learn (modality#1, see FIG. 3) trajectory-conditioned BVI movement command controller (modality#2, see FIG. 4), which accepts camera image as input, and outputs the motion command (e.g., forward, left or right turn). In this case, to prepare a navigation module for a particular trajectory, sighted users collect training data of the corresponding trajectory (see FIG. 1 and FIG. 3), which consists of a set of images paired with the motion information (forward, left or right turn) and is automatically extracted via RNN LSTM classifier from AMU data collected by a wearable component. Algorithm 2 is used to automatically label training data, which is further used to train the trajectory controller neural network.

Additionally, the object detection component is used to memorize and recognize places (e.g., end of the trajectory) and objects, which help navigation in the corresponding route (see FIG. 3). In modality#2 (see FIG. 4), a BVI user can add additional information to the route by creating location !Os, adding audio descriptions to particular places, etc. After the training procedure is complete, the output of the controller is presented to the BVI user via the audio-tactile display.

All the modules stream their outputs through a TCP/IP network, which is accessible to other required components. The outputs of the modules mentioned above are processed via “text-to-speech” and other algorithms and presented via audio-tactile display to the BVI user, which is calibrated by using Algorithm 3.

Note that modules 1-7 rely on mostly known algorithmic approaches (such as object detectors, scene captioning, etc.), and we do not include their detailed technical description since they are out of the scope of this invention. However, some of these algorithms also include essential innovations, which are described further.

Algorithm 1: CNN object detector data augmentation algorithm.

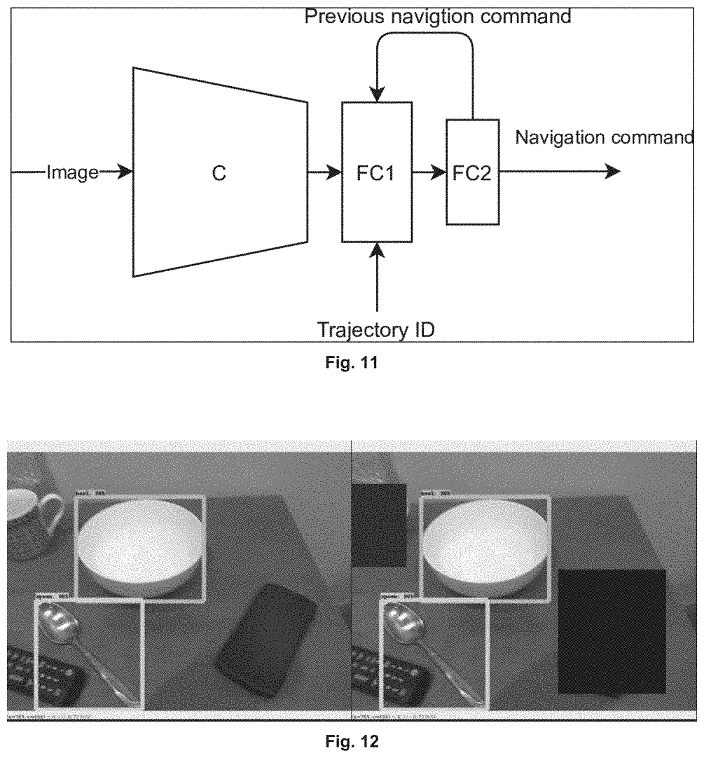

An object detection data augmentation algorithm is described herein, which includes information about object-like structures in the training data and helps make training more efficient. This algorithm allows for training object detector neural networks faster, which is important for the present invention. For example, in FIG. 12, the left image contains a scene with bounding boxes of “bowl” and “spoon” objects marked, and the right image contains the same scene with cup and phone object detected via an external fixed detector and masked out. That is, an object detection data augmentation algorithm automatically selects recognized objects for masking out. In this way, the main detector can exploit this auxiliary information during the training process. Such CNN training procedure increases noise prone recognition of objects and its robustness in various partial view settings.

Algorithm 2: Imitation-learning based controller for BVI user navigation.

Since manual labeling of images is a time-consuming process, an algorithm for the automated pairing of camera images with motion classes extracted from raw wearable IMU data is described herein. This algorithm is configured to automatically label training sets for the training of imitation-learning controllers, whose output corresponds to three movement classes (“forward”, “left”, “right”) and a prediction reliability estimate, which is important to our application:

2.1 Raw IMU time series of movement classes (“forward”, “left” “right”) are collected by separately executing the corresponding movement.
2.2 We use a convolutional LSTM classifier with four outputs (the first three outputs correspond to classes “′forward”, “left”, and “right”, and the fourth one is prediction reliability estimate). So tmax activation is used for the first three outputs, and sigmoid activation is used for prediction reliability estimates, The model is trained using modified cross-entropy (BICE) loss (1):

$$M C E ( x , y ) = - {\sum }_{c = 1}^{3} {y}_{c} log {y}_{c} ( x ) + {λ ( - {\sum }_{c = 1}^{3} {y}_{c} log {y}_{c} ( x ) - {y}_{4} ( x ) )}^{2} \qquad ( 1 )$$

where y_{c} is the ground truth label, and y_{c}(x) is the corresponding class prediction (probability).

### Algorithm 3: Transformation Between the Camera Image and Tactile Display Coordinates.

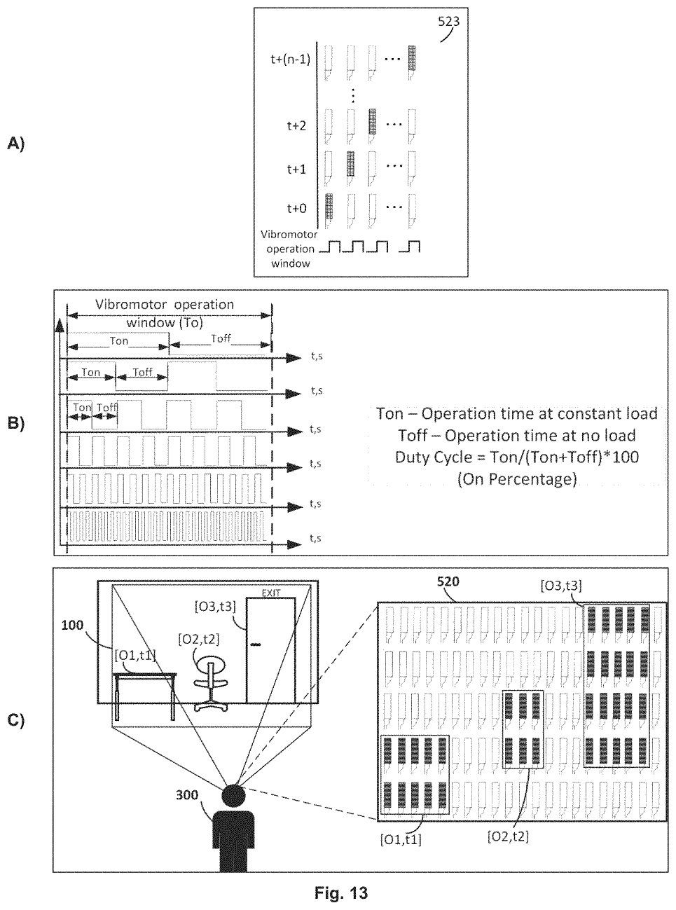

This transformation is required to represent rectangles in camera frames in tactile display vibro motor activations. We assume that the tactile display's coordinate frame is located at the top-left element (see FIG. 13C), and its orientation is the same as the orientation of the RGB camera image pixel coordinate frame. Because coordinate transformation between tactile display coordinate frame and both RGB camera coordinate frame and depth camera coordinate frame are static (FIG. 13), it can be stored in the configuration file or practically even omitted due to insignificant difference of coordinate origins. Therefore, the camera's rectangle (xp, yp, wp, hp) (top lowest point coordinates, width, and height) pixel space can be linearly mapped to a rectangle in Vibro display matrix (2):

$$( {x}_{p} , {y}_{p} , {w}_{p} , {h}_{p} ) \to ( [ \frac{{x}_{p} {W}_{m}}{{W}_{p}} ] , [ \frac{{y}_{p} {H}_{m}}{{H}_{p}} ] , [ \frac{{w}_{p} {W}_{m}}{{W}_{p}} ] , [ \frac{{h}_{p} {H}_{m}}{{H}_{p}} ] ) \qquad ( 2 )$$

where Wₚ and H₁ are image width and height respectively and Wₘ and Kᵣ, are numbers of vibromotors in columns and rows of the tactile display, and brackets [ ]” mean rounding up to the nearest integer operator.
Algorithm 4: Electromyography (EMG) command classifier.

This module accepts as input time-series data obtained from electromyography sensors and classifies these time series into a set of classes, which correspond to user commands. The classifier is based on convolutional LSTM RNN architecture, which allows working with unfiltered signals (filtering is implemented in the first layers of RNN and is adaptively learned in an end-to-end manner during model learning).

### Tactile, Myographic and Audio Feedback and Interface

When the ETA system is in the second modality (BVI navigation Mode#7), guiding directional information is transmitted to the BVI user 300 via audio voice (headphone 510) and tactile display 520 in a mutually coordinated manner. Thus, the system controller 600 starts the vibrating motors 523 one after another according to navigational movement direction—a running wave is formed as shown in FIG. 13A. Running waves can be simple (for instance, running wave to the right or the left; upward (forward) or downward (backward)) and composite (for instance, forward and then after x meters turning left or right; left or right and then after x meters forward; diagonally forward right or left, etc.). Simple running waves are predestined to show the immediate guiding direction a few steps ahead. According to user preferences or current situation, such an intuitive tactile user interface can be activated every T₀=[1;10] s (FIG. 13B) with desirable intensity.

Meanwhile, composite moving waves are meant to prepare BVI users 300 for the coming turning points (similarly to auto cars GPS navigators that are showing prospective turnings ahead of time). With EMG's 110 help, BVI users can choose a distance of X1=[2;15] meters for the ETA guiding system to warn about coming turning points ahead of time. It allows BVI users 300 to anticipate and prepare for future changes of movement directions.

According to FIG. 13C, when the ETA system is in the second modality (BVI navigation Mode#7), information about direction and distance to the identified object (obstacle, destination, or object of interest) is transmitted to the user via a tactile display 520 output interface. Depending on the object's location in the field of view, the set of vibrators 523 is activated in the tactile display 520 (FIG. 7). For instance, if the BVI ETA system's cameras 120, 150 identify an object on the top edge of the right side, then the top rightmost set of vibrators is activated in the tactile display; if system cameras face an object on the slightly down left side, then the slightly down left set of vibrators 523 is activated, etc. The size of the activated set of vibrators proportionally depends on the size of the identified object in the camera's field of view 100. The intensity of vibrations indicates the distance to the obstacle. Higher intensity of tactile activation of Vibro motors 523 means a closer distance to the object. With the help of EMG 110 or voice command, BVI users can choose tactile displaying period To=[1-5]s and vibration intensity. At the same time, bone-conductive headphones (they allow BVI to hear environmental sounds) can name an identified object.

According to FIG. 13C, when the camera depicts a few objects in the whole field of view 100 (operating Mode#1)—that can be unrecognized obstacles, recognized objects, and targets—then ETA system names (using bone-conductive headphones 510 or other headphones) and shows their location consequently one after another on the tactile display 520. For example, as shown in FIG. 13C, the cameras 120, 150 of BVI user 300 depict a table 01 at time #1, a chair 02 at time #2, and a door at time t3. These three objects 01, 02, and 03 are displayed on the tactile display at the respective times t1, #2, and t3.

According to FIG. 13C, if the BVI user 300 needs to focus only on one needed object (operating Mode#2), then he/she can direct his/her head, and correspondingly the is cameras 120, 150 to that object and have the object in the central field of view 100 It helps the BVI user 300 to pick only one object of the central field of view, correspondingly showing it in the central tactile view. Then the BVI user 300 can let the system work in the focusing mode (via EMG 110 signal code or audio command using a microphone 500) that leaves out all other objects from displaying on the tactile display 520 and tracks the chosen objects position. Such a focusing mode helps to focus attention and track the position of the needed object. Approaching this object increases the intensity of operation of vibratory motors 523.

We also foresee additional functionality - a zooming option of the central view. It could help BVI feel via tactile display more details of the chosen object, i.e., its heigh, form, and distance.

### DESCRIPTION OF CROWD-ASSISTED SOCIAL NETWORKING EMBODIMENTS

The indoor navigation system comprising methods for indoor routing in the first modality: In the presented system, buildings' indoor objects and routes are first explored and recorded by sighted sighted users using the ETA system and interface (see FIG. 1):
Sighted users go through the indoor routes, comment on objects, mark key guidance points (i.e., location ID points' visual and semantic ID). That is, sighted sighted users mark indoor landscapes, map navigational directions, and make comments, using the system's web crowd-assisted interface.
Data is collected in the web cloud database (DB),
Route updates are constantly sent from the sighted users and BVI users, using the ETA system.

This works through social networking when relatives, neighbors, friends, and other people voluntarily and periodically use the ETA system to record indoor routes most is important for BVI, see FIG. 14.

Therefore, even various daily changing indoor situations like renovations, furniture movements, dosed doors, and the like can be recorded and updated continually by sighted users through social networking in the web cloud DB. Sighted users and the ETA system can either guide around the obstacle or suggest another route to continue. Thus, is the presented web crowd-assisted innovative method enables BVI users to get the latest information about indoor routes' suitability.

Thus, in the web cloud DB, routes are analyzed, summarized, and enhanced using sighted users's records of multisensory data (location points' visual and semantic ID) and third-parties information (e.g., building floor plans, indoor maps, etc). The best statistical options for successful navigation are estimated each day in the web cloud DB, using deep neural networks or other artificial intelligence-based methods, see FIG. 14. BVI users can utilize processed navigational routes stored in the web cloud DB using the ETA system, and they get interactive indoor maps enhanced with the third parties' geospatial systems. In this way, By users, based on their preferences, can choose faster, shorter, stair-free, most used, best rated, most recent, or other routes' options.

After each guiding route's practical experience, BVI users (and correspondingly ETA system) can rate the route's validity, making personal averaged ratings ascribed to the route (and a sighted user who recorded it). It allows other BVI users to choose from the best-rated routes and to get off-line guidance from the best-rated sighted users.

### The Indoor Navigation System Comprising BVI Orientation and Navigation Method in the Second Modality:

After sighted users carry out indoor routes mapping with the ETA system in the first modality (see FIG. 1 and FIG. 3), route optimization for navigation consequently follows to the next (second) modality when BVI users can use such enhanced and optimized routes for orientation and navigation indoors (see FIG. 4). In the proposed invention, based on individual BVI user needs and preferences, the navigational ETA system helps to choose suitable route options (e.g., shortest, fastest, stair-free, guided by top-rated sighted user, etc.) using deep neural networks that step by step relate the route's object classes, location IDs, destinations, scenes, and semantic information (see Mg. 15). Routes adjusted to the individual needs can work online or offline. The latter is needed when there is no internet connection.

In the navigational mode, the BVI user's wearable ETA system generates a video and sensory data stream provided to the web cloud database and machine learning algorithms for analysis. In this way, objects, location IDs, scenes, and sensory data recognition occur almost in real-time to provide navigational guiding support for the BVI user.

When a BVI user gets lost or disoriented, the ETA system can work in a dead reckoning method, i.e., to guide to the last known location ID place (see Mg. 15 and Mg. 16). The system continuously tracks accelerometer, magnetometer, gyroscope, and compass information, which allows the BVI user to be traced back to the last known location ID. Such disorientation cases can be recorded, depersonalized, and processed to warn prospective BVI users and improve the route guiding quality.

While navigating indoors with ETA guiding system, the BVI user can approve, make estimates and additions to the route's DB navigation and orientation information (for instance, mark new objects, provide voice comments, make new location IDs, etc.). This information is used for improvements, validation, credibility, and rating of routes. Similarly, the BVI user can add to the route's comments regarding observed difficulties, inaccuracies, and errors.

Wayfinding and navigation indoor services for the BVI population generally have to perform one or more of the following functions: familiarization, localization, route planning, and communicating with the user in a meaningful manner through an accessible interface. The proposed experience-centric BVI user navigation system is wholly configured in such a way to achieve the following benefits:
1. A BVI user has more trust in human-based wayfinding experiences (trusted sighted users assistants or other BVI users who have similar needs and preferences) than computer-generated models and algorithms,
2. There is no need to compute routes and develop models based merely on the third parties' indoor schemes.
3. Various daily changing indoor situations can be recorded and updated continuously by sighted users through social networking in the web cloud DB.
4. Wayfinding experiences can be efficiently and effectively shared using social networking.

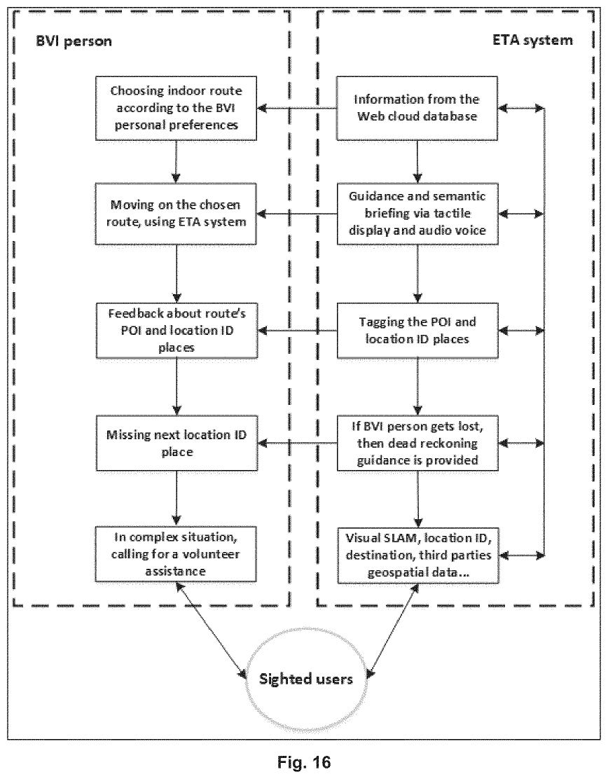

The above mentioned advantages work well only in the context of the whole ETA system (see FIG. 1 and FIG. 16), where:
1. Proposed visual odometry and SLAM (simultaneous localization and mapping) methods used for sequential recognition of route views have a competitive edge (comparing with other technologies) using modern advancements of deep neural networks (like Convolutional NN).
2. The proposed navigation and orientation method works as an augmented reality decision support system that enables better perception of indoor environments, which do not interfere with the natural BVI senses.
3. It eliminates a need for infrastructural installations like special marks on the floors, WiFi signals triangulation, beacons, installed Bluetooth devices, and so on.
4. BVI users can take an active part not only in the rating of passed routes but also in creating and improving them with the help of the ETA system and dedicated software subsystem.
5. Integration of third parties” geospatial indoor information gives additional information needed for matchmaking with the visual SLAM information.

### The Indoor Navigation System Comprising Web Crowd-Assisted Methods for Navigating Indoors in Complex Situations Using the Third Modality:

In real-life situations, even regularly updated navigational web cloud databases of indoor routes cannot assure unpredictable and complicated situations caused by accidents, other humans, machines, and BVI persons themselves. Thus, unlike other similar in-kind devices and systems, the present ETA system can provide real-time help in complex situations. For that matter, in the third modality, when a BVI user encounters complicated indoor navigation situation like a) deviation from the chosen route, b) unpredicted obstacles that block the traversed path, c) missing next location ID, and so on, then the BVI user can make a real-time video call to sighted users for online help to resolve the indoor problem. In this feature, sighted users can obtain almost real-time access to the BVI camera's view (see FIG. 16).

Before calling a sighted user, the ETA system can propose to the BVI user its way back to the last identified location ID place where the BVI person became lost. For that is reason, the ETA system recalls the recent multi-sensory data stream (walking directions and speed, distances of each straight walking segment) to make guiding instructions back. Machine learning algorithms process the situation, reexamine the route validity, and propose wayfinding guidance to include new location IDs or recognizable objects.

However, if that does not help, the BVI person can call a sighted person for real-‘s time help, using the third modality of the ETA system (see FIG. 16). In this way, with the BVI user's consent, the sighted person can see:
1. the current interactive indoor navigational route map stored in the online database,
2. the BVI user progress on the route,
3. passed and next expected views of location ID places,
4. a priori stored third party's information regarding the building's floor plan, indoor maps, or other geospatial orientation systems information.

Such information enables the sighted user to be more informative and better understand the problem's context. That is, it helps to see the problem from the grand perspective view as well as saving mobile connection time and making assisting efforts more effective.

It is important to note that the ETA system can provide a ranked list of sighted users who are most familiar with the place or problem the BVI user is facing,

The ETA system scans visual and sensory data to give feedback and help navigate to the next location ID place or the destination while a sighted user guides the BVI user.

The above-described web-crowd-assisted social networking support methods have been described in detail with particular reference to certain preferred aspects thereof, but it will be understood that variations, combinations, and modifications can be effected by a person of ordinary skill in the art within the spirit and scope of the invention.

### CITATION LIST (NON-PATENT LITERATURE)

1. Plikynas, D.; Žvironas, A.; Budrionis, A.; & Gudauskis, M. Indoor Navigation Systems for Visually Impaired Persons: Mapping the Features of Existing Technologies to User Needs. Sensors, 20(3), 2020,636.
2. Vatansever, S.; Butun, I. A broad overview of GPS fundamentals: Now and future. In

Proceedings of the 2017 IEEE 7th Annual Computing and Communication Workshop and Conference (CCWC), Las Vegas, NV, USA, 9-11 Jan. 2017; pp. 1-6.
3. Li, X. A GPS-Based Indoor Positioning System With Delayed Repeaters. IEEE Trans. Veh. Technol. 2019,68,1688-1701.
4. Chai, A.B.C.; Lau, B.T.; Pan, Z.; Chai, A.W.; Deverell, L.; Mahmud, A.A.; McCarthy, C.; Meyer, D. Comprehensive Literature Reviews on Ground Plane Checking for the Visually Impaired. In Technological Trends in Improved Mobility of the Visually Impaired; Paiva, S., Ed.; Springer International Publishing:: Cham, Switzerland, 2020; pp. 85-103 ISBN 978-3-030-16449-2.
5. Paiva, S.; Gupta, N. Technologies and Systems to Improve Mobility of Visually Impaired People: A State of the Art. hi Technological Trends in Improved Mobility of the Visually Impaired; Paiva, S., Ed.; Springer International Publishing: Cham, Switzerland, 2020; pp. 105-123 ISBN 978-3-030-16449-2.
6. Wold, E.Z.; Padoy, H. Indoor Navigation for the Visually Impaired - A Systematic Literature Review. 2016 Available online: https://folk.idi.ntnu.no/krogstie/project-reports/2016/padoy/FordypningsProsjekt.pdf (accessed on 21 Jan. 2020).
7. Budrionis, A., Plikynas, D., Daniusis, P., & Indrulionis, A. Smartphone-based computer vision travelling aids for blind and visually impaired individuals: A systematic review. Assistive Technology, 2020,1-17.

8. Raufi, B., Ferati, M., Zenuni, X., Ajdari, J., Ismaili, I. F. Methods and techniques of adaptive web accessibility for the blind and visually impaired. Procedia - Social and Behavioral Sciences, vol. 195, 2015, pp. 1999-2007.
9. Ferati, M., Raufi, B., Kurti, A., Vogel, B. Accessibility requirements for blind and visually impaired in a regional context: An exploratory study. 2nd International Workshop on Usability and Accessibility Focused,” Requirements Engineering, UsARE 2014, pp. 13-16, 2014.
10. Griffin-Shirley, N., Banda, D. R., Ajuwon, P. M., Cheon, J., Lee, J., Park, H. R., Lyngdoh, S. N. A survey on the use of mobile applications for people who are visually impaired,” Journal of Visual Impairment & Blindness, vol. 111(4), 2017, pp. 307-323.
11. Plikynas, A. Žvironas, M. Gudauskis, A. Budrionis, “Research Advances of Indoor Navigation for the Blind People: A Brief Review of Technological Instrumentation.” IEEE Instrumentation & Measurement Magazine, 2020, 23(4), pp. 22-32.
12. Csapó, A., Žvironas, G., Nagy, H., Stockman, T. A survey of assistive technologies and applications for blind users on mobile platforms: A review and foundation for research. Journal on Multimodal User Interfaces, vol. 9 (4), 2015, pp. 275-286.
13. Mauro, A., Wolf, K., Brock, A., Henze, N. Remote assistance for blind users in daily life: A survey about be my eyes. In Proceedings of the 9th ACM International Conference on PEivasive Technologies Related to Assistive Environments, 2016, pp. 1-2.

1, An electronic traveling aid (ETA) system for indoor navigation for Blind-and-Visually-Impaired (BVI) persons, wherein a user of the system is a BVI person or a sighted web-crowd assistant, and wherein the system comprises:
a wearable device, wherein the device is worn as a headband by a BVI user or a sighted user and contains input devices: an electromyograph (EMG), a microphone, an active depth camera, an inertial measurement unit (IMU), a light detector, an RGB camera; and output devices: bond-conductive earphones, a tactile display comprising vibro-elements; and a process bus;
a switch board device wherein the switch board device is configured to be attached to a white cane of the BVI user;
a personal mobile device of a user having wireless communication capabilities, and comprising a microprocessor, an RGB camera, and a is microphone, wherein the personal mobile device is a smartphone and wherein the mobile device and its mobile app are configured to take part in the web-crowd interface application that is used to transmit ETA system's data and establish communication between BVI user and sighted user;
a computer processor configured to perform machine learning processes;
a data storage device configured with a database management system;
a web server, wherein said web server, computer processor and storage medium are connected for data transmission by physical or wireless communication means; and
a control device, connected by wireless communication means to said web server and to said personal mobile device and configured to receive input signals from, and transmit output signals to said input and output devices by wireless communication means; and
wherein the system is configured to operate in three different modalities; and wherein the different modalities operate cooperatively,

2. The electronic traveling aid system of claim 1, wherein the computer processor is configured to preform machine learning processes including: object detection and class identifier, identification of specific (user defined) objects, audio description of visual scene, face recognition, optical character recognition, obstacle recognition, indoor navigation, and social networking; and wherein the functions can be executed simultaneously.

3. The electronic traveling aid system of claim 1, wherein the system is configured to operate in the first modality, and wherein:
the sighted user uses the wearable device to record video, audio commands, and IMU input;
the recorded user data is transmitted by wireless communication means to the computer processor configured for machine learning;
the recorded input from the sighted user is processed in the machine learning computer processor to produce navigational path data; and
said navigational path data is stored in the data storage device database.

4. The electronic traveling aid system of claim 1, wherein the system is configured to operate in the second modality, wherein:
a) input data from the wearable device, mobile device, or switch board of a BVI user is transmitted by wireless communication means to the control device, and the control device sends input data by wireless communication means to the web cloud server, machine learning processor and storage device database;
b) input data is processed by means of machine learning, neural networks, and object recognition algorithms and by database management means; and
c) processed data is transmitted from the web cloud server to the control device, and then to the output devices of the wearable device of a BVI user.

5. The electronic traveling aid system of claim 1, wherein in the system is configured to operate in the third modality, wherein:
the mobile device of a BVI user is configured to make voice and/or video calls to a sighted user by means of a web-crowd interface application; and
the mobile device of the sighted user is configured to receive a voice and/or video call from a BVI user by means of a web-crowd interface application, and the mobile device is configured to receive the BVI user's navigational path data, BVI user's location on the navigational path, and epassed and next expected location ID by means of the web-crowd interface application,

6. The wearable device according to claim 1, wherein said device is made of a waterproof material, is configured to be worn on the head of the BVI or sighted user, and comprises the following devices which are not visible from the exterior of the wearable device:
A tactile display interface, wherein the tactile display comprises an n-by-rn matrix of vibrational motors, which are activated in such a way as to form running waves with directional patterns (such as to the right, to the left, up, or down), or composite patterns (such as up or down and then left or right, diagonally up to the left or right, or any combination of directional patterns), and further configured such that the intensity of vibrations of the vibrating motors can vary;
bone-conducting earphones, which allow using ears for surrounding environmental sounds perception;
an electromyograph (EMG), wherein the EMG comprises at least three pairs of EMG electrodes which are embedded into the wearable device and are positioned such that one pair of electrodes are proximally located at each of: the lateral rectus muscle, the frontalis muscle, and the temporalis muscle of a BVI user;
the control device; and
further comprising a bandpass filter used to remove artifacts of movements or other biosignals, or interference signals from the tactile display.

7. A method of indoor navigation using the system of claim 3 consisting of:
the sighted user traversing an indoor space using the ETA system wherein the system is in an operational mode to record video, audio, and mark physical objects in the web-crowd interface application;
the sighted user providing visual, verbal or interactive commentary by means of the web-crowd interface application about the indoor space including navigational guidance, comments and classification of objects, marking location points and semantic IDs, rating of route validity and quality;
transmitting the sighted user-provided data to the web server by wireless communication means;
analyzing, summarizing and enhancing multi-sensory user-provided data together with spatial information from third parties, such as building plans or indoor maps;
estimating navigation routes for an indoor space from the sighted user-provided data by means of the computer processor configured for machine learning processes, and further providing qualitative data for each route such as: fastest, shortest, stair-free, most-used, best-rated, most-recent, or other user-defined qualities; and
storing navigational route data in the storage device database.

8. The method of indoor navigation of claim 7, wherein the navigational route data is updated when new audio, visual or interactive commentary is provided by a sighted user.

9. A method of indoor navigation using the system of claim 4, comprising guiding the BVI user by transmitting directional information via audio voice and tactile display in a mutually coordinated manner and further comprising representing the navigational movement direction via the tactile device;
wherein a “running wave” is formed by vibro-elements of the tactile device according to the navigational movement direction, such as;
a “running wave” to the right or to the left;
a “running wave” upward (forward) or downward (backward); or
a composite “running wave”, comprising a sequence of movement directions such as “forward and then turn left or right; left or right and then forward; diagonally forward right or left” or by any other sequence.

10. The method of indoor navigation of claim 9, further comprising detecting environmental features other than physical objects from an RGB camera image, including:
traversable/untraversable area, such as empty corridor among walls or overcrowded path;
place recognition and localization within the RGB images, such as recognized location ID and room direction, represented with a bounding rectangle; and
properties of physical objects such as filled/empty power outlet, open/closed door.

9. The method of indoor navigation of claim 9, further comprising detecting physical objects and presenting object-location information to the BVI user by means of tactile or audio output, the method further comprising:
augmenting data to improve object detection training efficiency, wherein an
input image comprises two or more concatenated images;
a first concatenated image being an image from an RGB camera; and
further one or more images are construed from said first image by masking-out objects, said objects being detected by machine learning object detection processes; and
representing the detected objects via the audio and tactile devices of the wearable device, wherein:
the bounding rectangle of a detected object is linearly mapped into the vibro-elements of the tactile device; and
the semantic or user-derived label of the detected object is converted to an audio signal by “text-to-speech” method, and translated to the BVI user via audiochannel, such as bone-conductive headphones.

12. The method of indoor navigation of claim 11, further comprising representing the direction and distance to an identified object via the tactile and audio devices of the wearable device, wherein the object location in the field of view of the camera and also of the wearable device is represented by the activated set of vibro-elements in the tactile display, wherein:
the size of the activated set of vibro-elements is proportional to the size of the object in the field of view;
the intensity of vibrations indicates the distance to the object; and
the name of the identified object is translated via audiochannel, such as bone-conductive headphones.

13. The method of indoor navigation of claim 11, further comprising zooming into an object(s) via the tactile, audio and EMG devices, wherein:
the system names, via audio channel, the object(s) in the field of view of the camera and the tactile device representation;
the BVI user directs the camera to select a particular object using EMG means; and
the BVI user instructs the system via EMG control interface to track and zoom the selected object(s) to be represented by the tactile device interface.

11. method of indoor navigation of claim 11, further comprising orienting the is BVI user to the requested object, wherein:
the BVI user selects, via EMG control interface, an object requested to reach or a direction requested to move; and
the directions for the BVI user to move are represented by the ETA system on the tactile display, using a ,running wave” and vibration intensity of the vibro-elements.

15. A method of indoor navigation using the system of claim 6, comprising a function of control using a electromyography (EMG) input for facial muscles to send commands to the ETA system, wherein:
at least, three pairs of EMG electrodes positioned above or close to:
the lateral rectus muscle, to observe the horizontal electrooculogram;
the frontalis muscle, to observe the raising of eyebrows; and
the temporalis muscle, to observe jaw clenching or left/right eye blinking;
EMG signals are calibrated to the BVI user to adjust control commands to the system; and
wherein the EMG control employs robust EMG codes which are sequences and/or patterns of facial muscle contractions, such as:
right eye blinking followed by the left eye blinking, or vice versa;
double lift of both eyebrows; or
any other time-adjusted successive or simultaneous contractions being rarely spontaneous; and
wherein the error-resistant EMG-codes and spontaneous artifacts of facial muscle contractions are machine-learned and recognized by deep neural networks or artificial intelligence methods, and filtered in EMG signals using duration time and bandpass filters.

15. The method of claim 15, further comprising validating EMG control commands to the ETA system by steps of:
the BVI user performs facial muscle contraction to issue an EMG signal to the system; and
the system receives the EMG signal, recognizes an EMG command, and returns the BVI user a tactile vibration or sound signal, confirming is receipt of the EMG command.

17. The method of indoor navigation of claim 9, further comprising updating the route information by the BVI user on the route, whereby approving, estimating, or adding information to the route, such as, marking new objects, providing voice comments, creating location IDs, whereby the information is validated, credited and rated in the system database, and further comprising adding comments on difficulties, inaccuracies and errors met on the route by the BVI user via the personal mobile device configured with the web-crowd interface application.

18. The method of indoor navigation of claim 9, further comprising a function to navigate the BVI user based on individual needs and preferences wherein:
selections and preferrences by the BVI user are collected, processed and rated in a profile of the individual BVI needs and preferences; and
said profile is used by the ETA system or the control device to select and adjust the routes to the BVI user.

19. The method of indoor navigation of claim 9, further comprising a function of dead reckoning, to guide the BVI user to the last known location ID, wherein the ETA system:
continuously tracks accelerometer, magnetometer, gyroscope, and compass information;
tracing the route back to the last known location ID in case of disorientation of the BVI user; and
recording, depersonalizeing, and processing the incident to the web-crowd database.

20. A method of indoor navigation using the system of claim 5, wherein the BVI user encounters an unresolvable situation from any of: deviation from the route, unpredicted obstacles, and missing ID of the next location; the method comprising the following steps:
the ETA system recalls and suggests the BVI user a way back to the last identified location ID before the BVI user has lost;
the ETA system calls a selected sighted user to resolve the problem;
the sighted user through the web crowd interface application obtains real-time access to the BVI user camera view; and
wherein, with consent of the BVI user, the sighted user obtains access, at least, to:
the current interactive indoor navigational route map stored in the online database;
progress of the BVI user on the route; and
the passed location IDs and next the expected views of location ID the sighted user interactively guides the BVI user through the available routes.
